(19) United States
(12) Patent Application Publication
(10) Pub. No.: US 2014/0055607 A1
(43) Pub. Date: Feb. 27, 2014

(54) GAME CHARACTER PLUGIN MODULE AND METHOD THEREOF

(71) Applicant: Jiunn-Kuang CHEN, Taipei City (TW)

(72) Inventor: Jiunn-Kuang CHEN, Taipei City (TW)

(21) Appl. No.: 13/591,244

(22) Filed: Aug. 22, 2012

(51) Int. Cl. H04N 7/18

(52) U.S. Cl. 348/143; 348/E07.085

(57) ABSTRACT

The present invention provides a game character plugin module and a method thereof for an electronic device having a display with an executable application software, said module comprises: an image capturing unit for displaying a capture frame on the display and controlling the capture frame to bordering a feature portion of an image on the display and to capture said portion to form a feature image; a resolution adjusting unit for automatically scaling a resolution of the feature image to match with a resolution of the background image of the application program; an image retrieving unit for replacing operational characters in the background image with the feature image of scaled resolution read by the application program such that the feature image of scaled resolution in the background image receives operations of controls and such that personal characterization thereof is achieved and the fun of the application is enhanced.

### BACKGROUND OF THE INVENTION

1. Technical Field

The present invention is related to a game character plugin module and a method thereof, in particular, to a module capable of using operational characters captured from an external image in an application program background of an electronic device, and to a method of replacing operational characters in an application program background with said externally captured image.

2. Description of Related Art

Varies application programs for smart phones and tablet computers or electronic devices can be downloaded from relevant internet shops or stores. Such application programs developed for smart phones and tablet computers or electronic devices as mentioned include various application categories of such as search, health, photography, education and gaming software.

Nevertheless, the characters or image drawings that can be operated or controlled via operating interface of electronic device offered by such programs and gaming software are pre-defined and users are not able randomly modifying or replacing these characters or images. They lack customized and personal characteristics; furthermore, the characters and the background images are not user friendly and the fun of playing or using these characters or images is yet to be enhanced. It is a challenge to the person skilled in the art in this field to overcome the abovementioned drawbacks.

### SUMMARY OF THE INVENTION

A module and method capable of using externally captured images to operate or control characters in an application program background of an electronic device in order to overcome the drawbacks of known arts mentioned above is provided. The drawback of having pre-defined characters or images operable or controllable via operating interface of an electronic device associated with current programs and gaming software, causing users unable to modify or replace randomly as well as lack of customization and personal characteristics can be overcome. Furthermore, the problem of having no further elevated fun of gaming or using such characters or images can be overcome by providing customization and personal characteristics to the game in order to enhance the effects of fun gaming or utilization of such characters or images.

The present invention provides a game character plugin module, provided in an electronic device utilizing a display and an operating interface with an executable application program, said electronic device having a control unit electrically connected to said display and operating interface, said module comprising:

An image capturing unit, electrically connected to said display and operating interface, said control unit displaying an image on said display, said image capturing unit displaying a capture frame on said display, and said control unit controlling said capture frame to bordering a feature portion of said image and to capturing said portion to form a feature image;

A resolution adjusting unit, electrically connected to said image capturing unit, and said resolution adjusting unit automatically scaling a resolution of said feature image such that said resolution of said feature image matching with a resolution of a background image of said application program;

A memory unit, electrically connected to said resolution adjusting unit, said resolution adjusting unit storing said feature image of said scaled resolution in said memory unit; and

An image retrieving unit, electrically connected to said memory unit and control unit; whereby during a period when said electronic device executing said application program and displaying said background image on said display, said image retrieving unit utilizing said feature image of said scaled resolution in said memory unit read by said application program controlled via said control unit as an operational character in said background image, such that said feature image of said scaled resolution receives operations in said background image.

Accordingly, the present invention is able to allow people, events, objects, landscape in a range coverable by the camera of a smart phone, table computer or electronic devices to be captured into the application program and to serve as a character or to form as a background such that personal customization of the application program, gaming software in particular, can be achieved and such that the objective of having the externally captured image to replace the operational character in the background of the application program of electronic device as mentioned above can be achieved; wherein:

In accordance with the abovementioned primary structures and features, said memory unit stores at least one preloaded image therein, said image retrieving unit utilizes said feature image of said scaled resolution or said preloaded image in said memory unit read by said application program controlled via said control unit as an operational character, such that said feature image of said scaled resolution or said preloaded image receives operations in said background image.

In accordance with the abovementioned primary structures and features, said control unit inputs said image via photographing by said electronic device, reading a database of said electronic device or downloading from internet by said electronic device.

In accordance with the abovementioned primary structures and features, said image capturing unit adjusts sizes of said capture frame, variables of photographs or sizes or shapes of a transparent area surrounding said capture frame via controls of said operating interface.

In accordance with the abovementioned primary structures and features, said image capturing unit controls feature portion of said image to be selected by said capture frame via controls of said operating interface, facial detections or automatic focusing methods.

In accordance with the abovementioned primary structures and features, said image capturing unit is able to capture an image within said display to form a complete image; said resolution adjusting unit is able to scale a resolution of said complete image such that said resolution of said complete image matches with said resolution of said background image; whereby during a period when said electronic device executes said application program, said image retrieving unit replaces said background image entirely or partially with said complete image of said scaled resolution read by said application program controlled via said control unit.

In accordance with the abovementioned primary structures and features, the present invention further comprises an image adjusting unit, electrically connected to said operating interface, said image capturing unit and said resolution adjusting unit; said image capturing unit displays said feature image or said complete image on said display for preview, and said image adjusting unit adjusts image variables of said feature image or said complete image via controls of said operating interface.

Furthermore, the present invention provides a method of plugging in a game character for an electronic device having a display and an operating interface with an executable application program, said method comprising the steps of:

displaying an image and a capture frame;

using said capture frame to bordering a feature portion of said image and to capturing said portion to form a feature image;

scaling a resolution of said feature image such that said resolution of said feature image matches with a resolution of a background image of said application program;

storing said feature image of said scaled resolution;

executing said application program and displaying said background image on said display; and

replacing an operational character in said background image with said feature image of said scaled resolution read by said application program, such that said feature image of said scaled resolution receives operations in said background image.

Therefore, the objective of using an externally captured image as an operational character in the application program background as mentioned above can be achieved; wherein:

In accordance with the abovementioned primary structures and features, before the step of executing said application program and displaying said background image on said display, a preloaded image is provided such that an operational character in said background image is replaced with said feature image of said scaled resolution or said preloaded image read by said application program, and such that said feature image of said scaled resolution or said preloaded image receives operations in said background image.

In accordance with the abovementioned primary structures and features, before the step of displaying said image on said display by said electronic device, said image is input via photographing by said electronic device, reading a database of said electronic device or downloading from internet by said electronic device.

In accordance with the abovementioned primary structures and features, before the step of using said capture frame to bordering said feature portion of said image, sizes of said capture frame, variables of photographs or sizes or shapes of a transparent area surrounding said capture frame are adjusted.

In accordance with the abovementioned primary structures and features, the step of using said capture frame to bordering said feature portion of said image utilizes manual, facial detection or automatic focusing methods to select said feature portion of said image.

In accordance with the abovementioned primary structures and features, before the step of automatically scaling said resolution of said feature image, said feature image is displayed on said display for preview and image variables of said feature image is adjusted.

In accordance with the abovementioned primary structures and features, the step of displaying said feature image on said display for preview is done by adjusting said resolution of said feature image to match with said resolution of said display.

In accordance with the abovementioned primary structures and features, the present invention further comprises the steps of: after displaying said image on said display, capturing said image within said display to form a complete image; scaling a resolution of said complete image such that said resolution of said complete image matches with said resolution of said background image; and during executing said application program, replacing said background image entirely or partially with said complete image of said scaled resolution read by said application program.

In accordance with the abovementioned primary structures and features, before the step of scaling said resolution of said complete image, said complete image is displayed on said display for preview and image variables of said complete image is adjusted.

In accordance with the abovementioned primary structures and features, after the step of replacing said background image with said complete image of said scaled resolution, said image is displayed on said display by a way of scrolling.

In comparison with the prior arts, the present invention is of the following merits:

1. Images of any people, events, object or landscape that are present in the range coverable by cameras of smart phones or tablet computers can be captured and further modified or adjusted for program utilization as operational characters or backgrounds in application programs, such as gaming software. With the increasing awareness of self-recognition, applications capable of providing images captured from current or present scene as a first-hand interaction and experience is able to demonstrate customization and personal characteristics while enhancing the fun of gaming during its operation or usage.

2. The range of images to be captured for use can extend to online albums or mobile phone albums such that the sources of images are diverse with ease of capturing.

3. It is possible to integrate such images captured into a current and common gaming software via special packages and promotions such that the images captured can serve as one of the main/supporting characters or background.

### BRIEF DESCRIPTION OF THE DRAWINGS

FIG. 1 shows a functional block diagram of a module of the present invention;

FIG. 2 shows a flow chart of a method of the present invention;

FIG. 3 shows a display of an embodiment of the present invention;

FIG. 4 is an illustration showing a next state of use of FIG. 3;

FIG. 5 shows a display of image capturing of the present invention;

FIG. 6 shows a display of another embodiment of the present invention;

FIG. 7 shows a display of still another embodiment of the present invention; and

FIG. 8 shows a display of still another embodiment of the present invention.

### DESCRIPTION OF EMBODIMENTS OF THE INVENTION

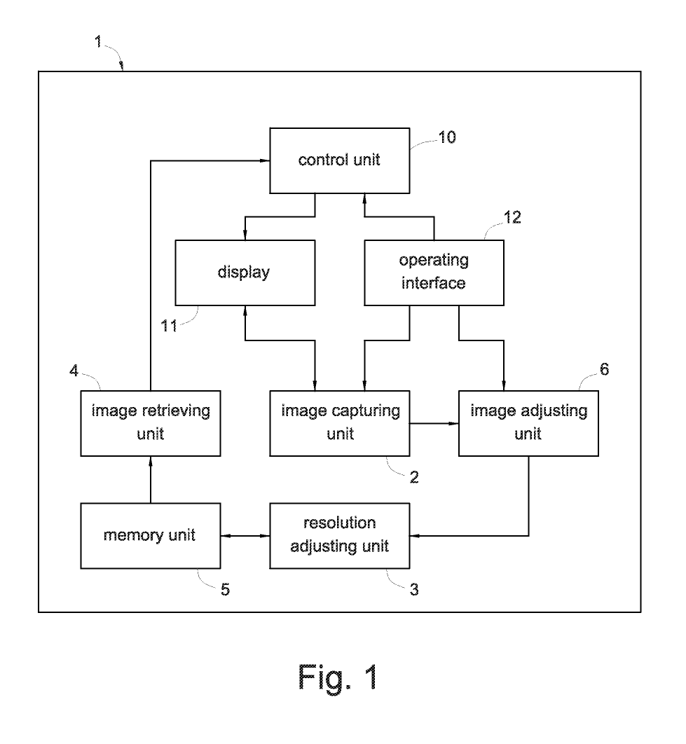

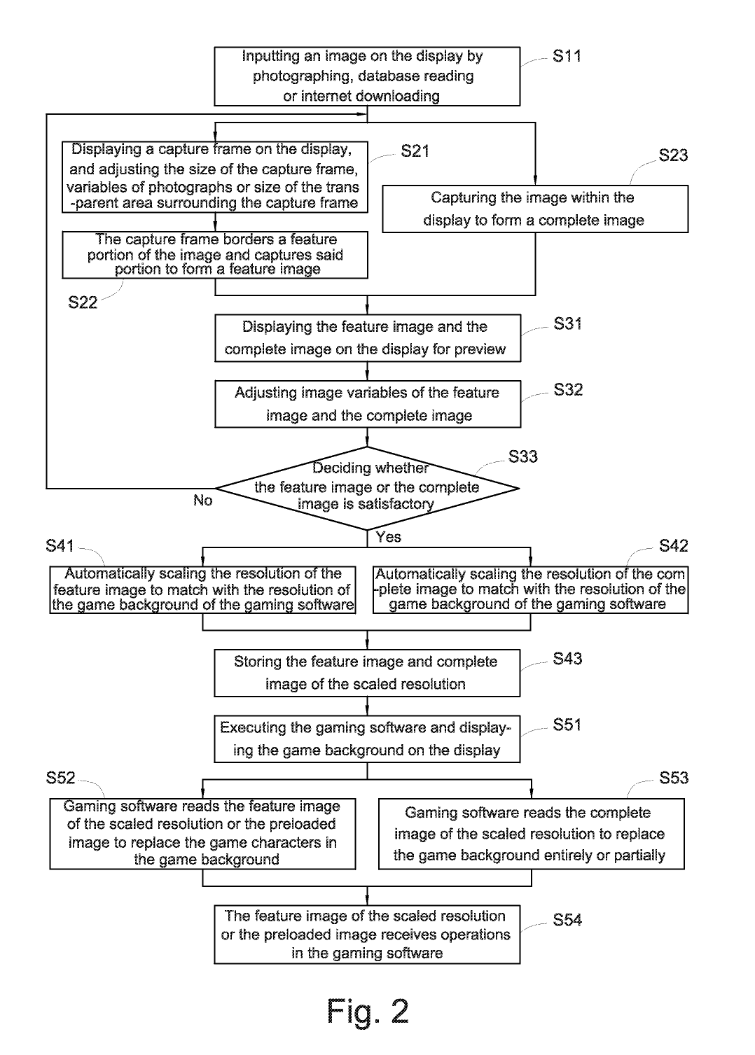

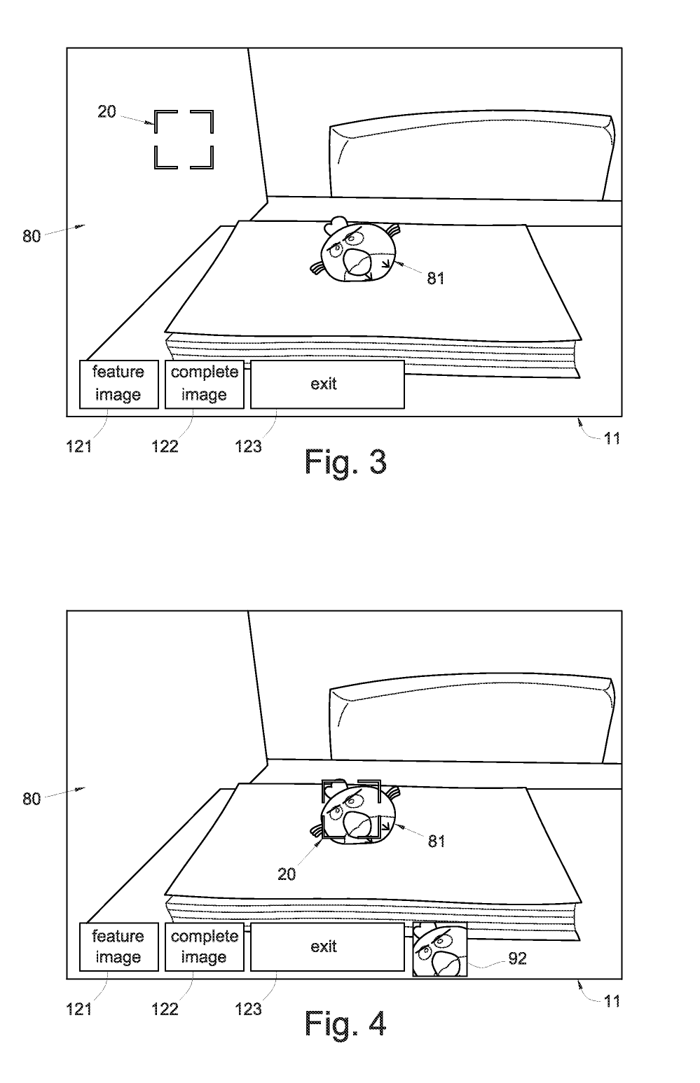

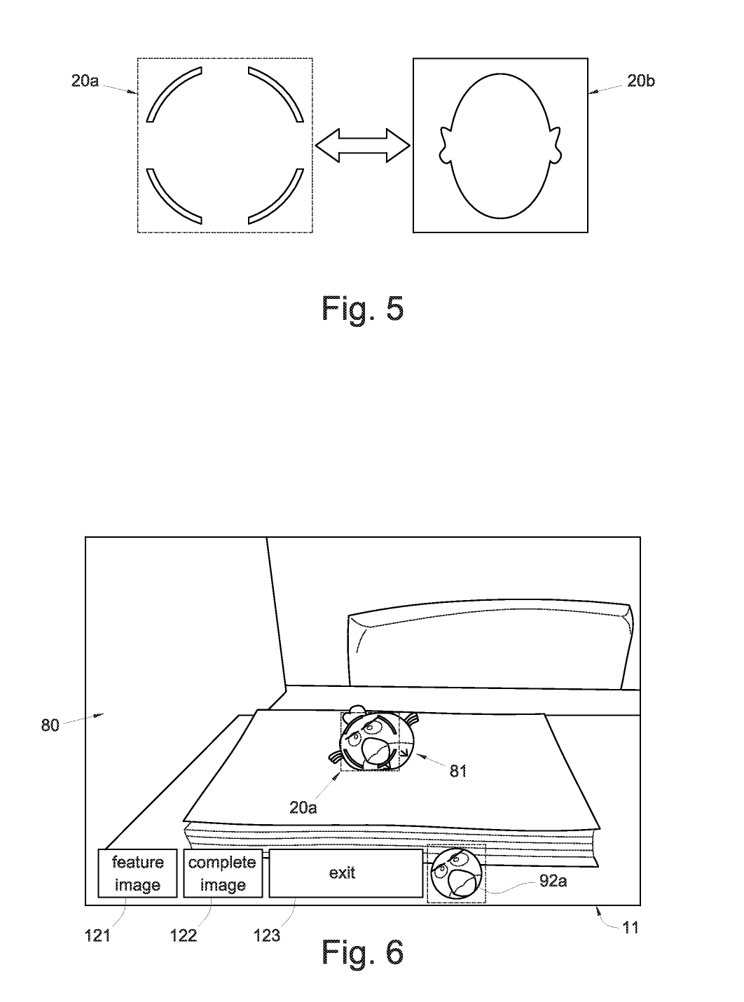

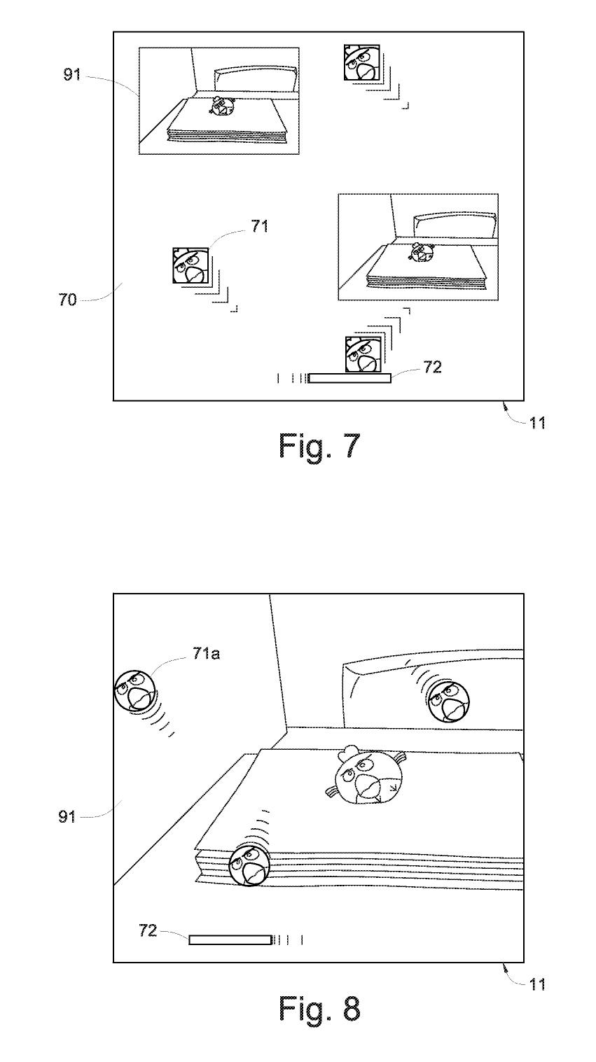

FIGS. 1 to 8 illustrates a game character plugin module of the present invention, provided in an internal of an electronic device 1 utilizing a display 11 and an operating interface 12 with an executable application program, said electronic device 1 having a control unit electrically connected to the display 11 and the operating interface 12.

The application program includes such as search, health, photography, education and gaming software. The embodiment of the application program uses the gaming software as an example. The electronic device 1 can be a smart phone, tablet computer or 3C electronics. The display 11 can be a LCD display. The operating interface 12 can be buttons, joysticks, keyboards, touch keys, touch panel or motion sensor inputs.

The game character plugin module of the present invention comprises an image capturing unit 2, a resolution adjusting unit 3, a memory unit 5 and an image retrieving unit 4; imaging capturing unit 2, resolution adjusting unit 3, image retrieving unit 4 and control unit 10; wherein:

The image capturing unit 2 is electrically connected to said display 11 and operating interface 12; the user is able to manually control said control unit 10 via the operating interface 12 to display an image 80 on the display 10; said image capturing unit 2 is able to display a capture frame 20 of a transparent rectangular frame configuration on the display 11; the user is able to manually control the image capturing unit 2 to drive the capture frame 20 to move via the operating interface 12 such that the image capturing unit 2 controls the capture frame to bordering or framing a feature portion 81 of the image 80 and to use the capture frame 20 to capture the feature portion 81 in order to form an feature image 92.

The resolution adjusting unit 3 is electrically connected to the image capturing unit 2 and the resolution adjusting unit 3 is able to automatically scaling up or down a resolution of the feature image 92 by automatically adjusting the DPI (Dots Per Inch) of the feature image 92 such that the resolution of the feature image 92 matches with a resolution of the background image 70 of a gaming software of an application program as an embodiment of the present invention.

The memory unit 5 is electrically connected to the resolution adjusting unit 3; said resolution adjusting unit 3 can store the feature image 92 of said scaled resolution in the memory unit 5, and the memory unit 5 can store in advance at least one preloaded image.

The image retrieving unit 4 is electrically connected to said memory unit 5 and control unit 10; whereby during a period when said electronic device 1 is executing said application program and displaying said background image 70 on the display 11, the image retrieving unit 4 is able to read via the API (Application Programming Interface) of a gaming software of the application program as an embodiment of the present invention or read directly said feature image 92 of said scaled resolution or said preloaded image in said memory unit 5 via said control unit 10, such that the feature image 92 of said scaled resolution or the preloaded image can replace as an operational character 71 in the background image 70 and such that the feature image 92 of said scaled resolution or the preloaded image can act as the operational character 71 in the background image 70 and can receive operations or controls of the user input via the operating interface 12.

Furthermore, in a preferably specified embodiment, the present invention further comprises:

The user is able to manually control the control unit 10 via the operating interface 12 to input the image 80 via photographing by said electronic device 1, reading a database of said electronic device 1 or downloading from internet by said electronic device 1.

When a touch panel is used as the operating interface 12, the display 11 and the operating interface 12 are attached to each other. The image capturing unit 2 can display a first capturing key 121 of a feature image 92, 92a on the operating interface 12 via the display 11. As the feature portion 81 of the image 80 is bordered or framed by the capture frame 20, 20a, the user can click the first capturing key 121 on the operating interface 12 such that the feature portion 81 captured by the capture frame 20, 20a forms feature images 92, 92a and the first capturing key 121 is displayed with captions of “feature image” as a notification.

The user can manually control the image capturing unit 2 via the operating interface 12 to adjust the size of the capture frame 20, the variables of photographs or the size and shape of the transparent area surrounding the capture frame 20. The capture frame 20 is a rectangular area and includes transparent and non-transparent areas. The non-transparent area a frame that is normally used for positioning or bordering targets and can be drawn to have various curves. When such rectangular overlaps with the background pixels 80 and as we adapts RGBA technology to adjust the transparency of the overlaps of the rectangular with the pixels of the image 80, A referring to alpha channel value, in order to make the rectangular portion transparent to show the background 80, Alpha is adjusted to be 0% and the non-transparent portion of the rectangular is of an Alpha being adjusted to be 100%. For greater looks on the appearance, the Alpha can be adjusted to have a mixture of colors. By doing so, the contours and shapes of the capture frame 20 can be adjusted. For example, when the shape of the capture frame 20 is adjusted to be rectangular, the feature image 92 captured from the image 80 can too be of a rectangular shape such that the shape of the operational character 71 is also rectangular. When the shape of the capture frame 20a is adjusted to be round, the feature image 92a captured from the image 80 can too be of a round shape such that the shape of the operational character 71a is also round. When the shape of the capture frame 20b is adjusted to be of a human face shape, the feature image captured from the image 80 can too be of a human face shape and can be used as a replacement for the face of the operational character.

The user can manually control the image capturing unit 2 via the operating interface 12 to activate the capture frame 20 to select any feature portion 81 on the image 80; or the image capturing unit 2 can use the facial detection or automatic focusing methods adapted in photography to control the capture frame 20 to automatically select the feature portion 81 on the image 80.

The user can also manually control the image capturing unit 2 via the operating interface 12 to capture the image 80 within the display 11 to form a complete image 91. The resolution adjusting unit 3 is able to automatically scaling the resolution of the complete image 91 such that the resolution of the complete image 91 matches with the resolution of the background image 70. During the period when the control unit 10 of the electronic device 1 executes or runs the gaming software of the application program as an embodiment of the present invention, the image retrieving unit 4 can replace the background image 70 entirely or partially with the complete image 91 of said scaled resolution read by the gaming software of the application program of the embodiment of the present invention via the controlling unit 10.

The image capturing unit 2 can also display a second capturing key 122 of the complete image 91 on the operating interface 12 via the display 11. The user can click on the second capturing key 122 on the operating interface 12 to activate the image capturing unit 2 to capture the image 80 within the display 11 to form a complete image 91 and the second capturing key 122 can too display the captions of “complete image” as a notification.

The present invention further comprises further comprises an image adjusting unit 6, electrically connected to the operating interface 12, the image capturing unit 2 and the resolution adjusting unit 3; said image capturing unit 2 can display the feature image 92, 92a or the complete image 91 on the display 11 for user's preview, and the user can manually control the image adjusting unit 6 via the operating interface 12 to adjust image variables of the feature image 92, 92a or said complete image 91; said image variables include color, brightness, image elongation, image shrinkage and image stretching.

The image capturing unit 2 can display a third capturing key 123 of a display for exiting capturing on the operating interface 12 via the display 11. When image variables of the feature image 92, 92a or the complete image 92 have been adjusted with satisfaction, the sure can click on the third capturing key 123 on the operating interface 12 to exit the capturing on the display 11 such that the image capturing unit 6 is able to automatically scaling the resolutions of the feature image 92, 92a or the complete image 91, and the third key 123 is also displayed with the captions of “exit” as a notification.

In view of the abovementioned structures and configurations, a method of plugging in game character of the present invention can be realized, said method of the present invention can be an application program for an electronic device 1 utilizing a display 11 and operating interface 12 with an executable application program, said method comprises the steps of:

Step S11: switching on the power of a smart phone or tablet computer of an electronic device 1 and activating the application program provided by the method of the present invention; manually controlling the control unit 10 of the electronic device 1 via the operating interface 12 to input an image 80 of people, event, object or landscape via camera photographing by the electronic device 1, reading an album database of the electronic device 1 or downloading from internet by the electronic device 1 and displaying said image 80 on the display 11. In this situation, the electronic device 1 can be using standalone or multi-communicational mode. Multi-communicational mode allows a number of machines to capture images and to transmit images among each other to form a part of the gaming software or program.

Step S21: once the power of the electronic device 1 is switched on, the image capturing unit 2 displays the capture frame 20, 20a, 20b, the first capturing key 121, the second capturing key 122 and the third capturing key 123 on the display 11; the capture frame 20, 20a, 20b are of a predefined frame size to facilitate user to select the capturing size from the image 80; the image capturing unit 2 can be manually controlled via the operating interface 12 to adjust the sizes of capture frame 20, 20a, 20b, the variables of photographs (such as focus, shots, etc.) or the size of the transparent area surrounding the capture frame 20, 20a, 20b. By adjusting the size of the transparent area surrounding the capture frame 20, 20a, 20b, the shape and contour of the capture frame 20, 20a, 20b can be adjusted to be of any shapes.

The order of Step S11 of displaying image 80 on the display 11 and Step S21 of adjusting the capture frame 20, 20a, 20b on the display 11 can be interchanged with each other or reversed.

Step S22: the image capturing unit 2 is manually controlled via the operating interface 12 to activate the capture frame 20, 20a, 20b to select and bordering any one of the feature portion 81 on the image 80; or the image capturing unit 2 can also control the capture frame 20, 20a, 20b to automatically select and bordering the feature portion 81 of the image 80. Therefore, the user can use the capture frame 20, 20a, 20b to capture images 80 of one's self-portrait (such as self-camera shots), friends or landscape and can then click on the first capturing key 121 on the operating interface 12 to form a feature image 92, 92a from the captured feature portion 81.

Step S23: one can decide whether to capture the image 80 within the display 11 or not during its usage; if capturing of the image 80 within the display 11 is desired, user can click on the second capturing key 122 on the operating interface 12 and a complete image 91 is then formed from the captured image 80 within display 11, which would too be integrated as a game background in the following processes.

Step S31: displaying the feature images 92, 92a and the complete image 91 on the display 11 for user's preview; the feature images 92, 92a can be displayed at a location adjacent to the third capturing key 123 on the display 11.

Step S32: user can manually adjust the image variables of the feature images 92, 92a and the complete image 91 via the operating interface 12; said step of adjusting the image variables comprises:

Shape treatment: allowing the shapes of the feature image 92, 92a and complete image 91 to be adjusted for treatments of stretching and deformation to enhance the gaming effects.

Color treatment: as image quality may sometimes be affected to be of different qualities due to the camera, scenes for photographs and lighting variables, it is therefore possible to use the feature images 92, 92a captured from the image 80 to compare with the background and to further adjust the brightness, saturation and peaking of the feature images 92, 92a such that the treated feature images 92, 92a can be incoherence with the background; for example, once the skin tone of a character is recognized, the skin tone can then be adjusted to be of a red color in greater depth.

The preview step of the feature images 92, 92a on the display 11 is done by automatically adjusting the resolution of the feature images 92, 92a to match with the resolution of the display 11 for preview.

Step S33: through the preview of the feature images 92, 92a and the complete images 91 on the display 11, the user can then decide whether the adjusted image variables of the feature images 92, 92a and the complete image 91 are satisfactory or not and to decide whether re-capturing the feature images 92, 92a and the complete image 91 or not. When the adjusted image variables of the feature images 92, 92a and the complete images 91 are found to be unsatisfactory, Step S21 can be repeated again until the adjustment thereof is satisfactory to the user. Once the adjustment thereof is satisfactory, the user can then click on the third capturing key 123 on the operating interface 12 to close the capturing mode of the electronic device 1 and exit the capturing display.

Step S33 can also be performed earlier between Step S31 and Step 32, and once the capturing of the image 80 is satisfactory, the image variables can then be adjusted.

Step S41: the resolution adjusting unit 3 automatically scaling up or down the resolution of the feature images 92, 92a such that the resolution of the feature images 92, 92a matches with the resolution of the background image 70 of the application program. When the resolution of the feature image 92, 92a is greater than the resolution of the background image 70, the resolution of the feature images 92, 92a is scaled down to match with the resolution of the background image 70. When the resolution of the feature image 92, 92a is smaller than the resolution of the background image 70, the resolution of the feature images 92, 92a is scaled up to match with the resolution of the background image 70.

The abovementioned scaling up or down is mainly directed to the scaling of the properties of (1) a first width, a first height of the resolution of the display 11; (2) a second width, a second height of the preview image; (3) a third width, a third height of the resolution of the image 80. Since mobile phones or computers of electronic device 1 can have the abovementioned three types of properties of display due to the orientation of the device in either landscape or portrait, by adjusting the size of the image 80 (i.e. games) to accommodate needs and by scaling the resolution thereof, the user would perceive the captured image under such three conditions as of a uniform size to achieve the effect showing an unity of the image 80 before and after such adjustment or treatment.

Step S42: the resolution adjusting unit 3 automatically scales up or down the resolution of the complete image 91 such that the resolution of the complete image 91 matches with the resolution of the background image 70. When the resolution of the complete image 91 is greater than the resolution of the background image 70, the resolution of the complete image 91 is scaled down to match with the resolution of the background image 70. When the resolution of the complete image 91 is smaller than the resolution of the background image 70, the resolution of the complete image 91 is scaled up to match with the resolution of the background image 70.

Step S43: storing the feature images 92, 92a of said scaled resolution and the complete image 91 in the memory unit 5 such that the information of the feature images 92, 92a is packaged and can be provided by the method of API (interface) as SDK (as .jar under Java) to the application program of the electronic device 1 or authorized game developers for their further uses.

Step S51: the electronic device 1 executes or runs the gaming software of the application program of the embodiment of the present invention and the background image 70 of the gaming software is displayed on the display 11.

Step S52: Having the gaming software of the application program of the embodiment of the present invention reading the feature images 92, 92a of said scaled resolution or the preloaded image in the memory unit via either API reading or direct reading; using the feature images 92, 92a of said scaled resolution or the preloaded image as the operational characters 71, 71a in the background image 70.

Step S53: replacing the background image 70 entirely or partially with the complete image 91 of said scaled resolution via API reading or directly reading by the gaming software of the application program of the embodiment of the present invention.

Step S54: having the feature images 92, 92a of said scaled resolution that serve as operational characters 71, 71a in the background image 70 to receive operations; for example, to have the operational characters 71, 71a to be drop from a upper part of the display 11 with a projecting line and to jump then fall downward with a projecting line. The complete image 91 can be etched onto the background image 70 or completely replacing the background image 70. The lower part of the display 11 can be provided with a horizontally moveable blocking plate 72, and the user can manually control the movement of the blocking plate 72 via the operating interface 12 such that the operational characters 71, 71a fall within the range of the blocking plate 71, keeping the operational characters 71, 71a continuously jumping; whereas if the operational characters 71, 71a fall outside of the blocking plate 72, the speed of the jumping of the operational characters 71, 71a is reduced to stationary; the greater the number of times blocked by the blocking plate 72, the higher the score gained.

During the Step S52, Step S53 and/or Step S54, Step S21 can still be carried out repeatedly to re-adjust the image variables of the feature images 92, 92a and the complete image 91.

Once the background image 70 is being replaced by the complete image of said scaled resolution and as the width of the complete image 91 is greater than the one of the display 11, it can be shown on the display 11 by a way of scrolling, such as a running text shown repeatedly.

Accordingly, as the people or images captured for the feature images 92, 92a are being processed by SDK and imported into various games, they can be used as the game character (i.e. operational characters 71, 71a) or stage scene (or partial scene) in the gaming software. A great number of game character scenes would capture images from one to multiple of image files of predefined size. Basically, the features images 92, 92a captured would be processed by image compression to allow the application program of the electronic device 1 or authorized game developer to read the feature images 92, 92a via API reading or direct reading such that the personal customization of application program, gaming software in particular, is achieved and such that the objective of using externally captured images to replace the operational characters 71, 71a in the application program can be achieved to enhance the fun of gaming during its usage.

In view of the above, the present invention describes the preferred embodiments for illustrative purpose only and shall be treated as limitations to the present invention. Modifications or substitutions of parts shall be considered to be within the spirit of the present invention and shall be within the scope of the claims set forth in the following.

What is claimed is:

1. A game character plugin module, provided in an electronic device utilizing a display and an operating interface with an executable application program, said electronic device having a control unit electrically connected to said display and operating interface, said module comprising:
an image capturing unit, electrically connected to said display and operating interface, said control unit displaying an image on said display, said image capturing unit displaying a capture frame on said display, and said control unit controlling said capture frame to bordering a feature portion of said image and to capturing said portion to form a feature image;
a resolution adjusting unit, electrically connected to said image capturing unit, and said resolution adjusting unit automatically scaling a resolution of said feature image such that said resolution of said feature image matching with a resolution of a background image of said application program;
a memory unit, electrically connected to said resolution adjusting unit, said resolution adjusting unit storing said feature image of said scaled resolution in said memory unit; and
an image retrieving unit, electrically connected to said memory unit and control unit; whereby during a period when said electronic device executing said application program and displaying said background image on said display, said image retrieving unit utilizing said feature image of said scaled resolution in said memory unit read by said application program controlled via said control unit as an operational character in said background image, such that said feature image of said scaled resolution receives operations in said background image.

2. The game character plugin module as claimed in claim 1, wherein said memory unit stores at least one preloaded image therein, said image retrieving unit utilizes said feature image of said scaled resolution or said preloaded image in said memory unit read by said application program controlled via said control unit as an operational character, such that said feature image of said scaled resolution or said preloaded image receives operations in said background image.

3. The game character plugin module as claimed in claim 1, wherein said control unit inputs said image via photographing by said electronic device, reading a database of said electronic device or downloading from internet by said electronic device.

4. The game character plugin module as claimed in claim 1, wherein said image capturing unit adjusts sizes of said capture frame, variables of photographs or sizes or shapes of a transparent area surrounding said capture frame via controls of said operating interface.

5. The game character plugin module as claimed in claim 1, wherein said image capturing unit controls feature portion of said image to be selected by said capture frame via controls of said operating interface, facial detections or automatic focusing methods.

6. The game character plugin module as claimed in claim 1, wherein said image capturing unit is able to capture an image within said display to form a complete image; said resolution adjusting unit is able to scale a resolution of said complete image such that said resolution of said complete image matches with said resolution of said background image; whereby during a period when said electronic device executes said application program, said image retrieving unit replaces said background image entirely or partially with said complete image of said scaled resolution read by said application program controlled via said control unit.

7. The game character plugin module as claimed in claim 6, further comprises an image adjusting unit, electrically connected to said operating interface, said image capturing unit and said resolution adjusting unit; said image capturing unit displays said feature image or said complete image on said display for preview, and said image adjusting unit adjusts image variables of said feature image or said complete image via controls of said operating interface.

8. A method of plugging in a game character for an electronic device having a display and an operating interface with an executable application program, said method comprising the steps of:
displaying an image and a capture frame;
using said capture frame to bordering a feature portion of said image and to capturing said portion to form a feature image;
scaling a resolution of said feature image such that said resolution of said feature image matches with a resolution of a background image of said application program;
storing said feature image of said scaled resolution;
executing said application program and displaying said background image on said display; and
replacing an operational character in said background image with said feature image of said scaled resolution read by said application program, such that said feature image of said scaled resolution receives operations in said background image.

9. The method of plugging in a game character as claimed in claim 8, wherein before the step of executing said application program and displaying said background image on said display, a preloaded image is provided such that an operational character in said background image is replaced with said feature image of said scaled resolution or said preloaded image read by said application program, and such that said feature image of said scaled resolution or said preloaded image receives operations in said background image.

10. The method of plugging in a game character as claimed in claim 8, wherein before the step of displaying said image on said display by said electronic device, said image is input via photographing by said electronic device, reading a database of said electronic device or downloading from internet by said electronic device.

11. The method of plugging in a game character as claimed in claim 8, wherein before the step of using said capture frame to bordering said feature portion of said image, sizes of said capture frame, variables of photographs or sizes or shapes of a transparent area surrounding said capture frame are adjusted.

12. The method of plugging in a game character as claimed in claim 8, wherein the step of using said capture frame to bordering said feature portion of said image utilizes manual, facial detection or automatic focusing methods to select said feature portion of said image.

13. The method of plugging in a game character as claimed in claim 8, wherein before the step of automatically scaling said resolution of said feature image, said feature image is displayed on said display for preview and image variables of said feature image is adjusted.

14. The method of plugging in a game character as claimed in claim 13, wherein the step of displaying said feature image on said display for preview is done by adjusting said resolution of said feature image to match with said resolution of said display.

15. The method of plugging in a game character as claimed in claim 8, further comprises the steps of:
after displaying said image on said display, capturing said image within said display to form a complete image;
scaling a resolution of said complete image such that said resolution of said complete image matches with said resolution of said background image; and
during executing said application program, replacing said background image entirely or partially with said complete image of said scaled resolution read by said application program.

16. The method of plugging in a game character as claimed in claim 15, wherein before the step of scaling said resolution of said complete image, said complete image is displayed on said display for preview and image variables of said complete image is adjusted.

17. The method of plugging in a game character as claimed in claim 15, wherein after the step of replacing said background image with said complete image of said scaled resolution, said image is displayed on said display by a way of scrolling.
